(19) United States
(12) Patent Application Publication
(10) Pub. No.: US 2008/0123619 A1
(43) Pub. Date: May 29, 2008

(54) APPARATUS, METHOD, AND COMPUTER READABLE MEDIUM THEREOF FOR DIVIDING A BEACON INTERVAL

(75) Inventors: Li-Chun Ko, Taipei (TW); Chih Lung Chang, Jhonghe City (TW); Hua-Wei Fang, Kaohsiung City (TW); Chih-Hung Hung, Sinjhuang City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/697,135

(22) Filed: Apr. 5, 2007

(30) Foreign Application Priority Data
Nov. 23, 2006 (TW) 095143324

(51) Int. Cl. H04J 3/00

(52) U.S. Cl. 370/345

(57) ABSTRACT

An apparatus, a method, and computer readable medium thereof for dividing a beacon interval are provided. The beacon interval is divided into a plurality of sub-beacon intervals in various sizes and each of the sub-beacon intervals is further divided into a predetermined number of time slots. Each of the sub-beacon intervals is similar to the beacon interval, and the difference between them is their time lengths. Therefore, more time slots in various sizes are provided. Consequently, nodes covered by the beacon interval can choose suitable time slots to transmit data to reduce waste of bandwidth. In addition, more time slots that are sub-contention free periods are provided, so transmitting data via time slots that are sub-contention access periods can be prevented. It means that collisions and data transmission can be reduced as well.

This application claims priority to Taiwan Patent Application No. 095143324 filed on Nov. 23, 2006.

### CROSS-REFERENCES TO RELATED APPLICATIONS

Not applicable.

### BACKGROUND OF THE INVENTION

1. Field of the Invention

The present invention relates to an apparatus, a method, and a computer readable medium thereof for dividing a beacon interval. More particularly, the present invention relates to an apparatus, a method, and a computer readable medium thereof for dividing a beacon interval into a plurality of sub-beacon intervals in various sizes.

2. Descriptions of the Related Art

Recently, wireless sensing networks have been rapidly developed because of their low cost, low power consumption, and easy building. Wireless sensing networks are especially suitable for applications with low maintenance requirements and wide service ranges. A wireless sensing network is usually constructed by a beacon network whose characteristic is that mother nodes in the network, master nodes and all hopping nodes, send network beacon signals at the same beacon interval frequency in order to synchronize the timing to transmit data to child nodes of the same beacon network. There are two major advantages in using a beacon network. First, the beacon network allows all the nodes to enter a sleep mode in an inactive period. Second, the beacon network provides a mechanism to maintain service quality; that is, schedules transmission requests of the nodes by an approach similar to time-multiplexing. Currently, the IEEE 802.15.4 standard has the clearest definitions in the operations and the architectures among the standards adapted for a beacon network.

Network equipments suitable for the IEEE 802.15.4 standard can be classified into a Full-Function Device (FFD) and a Reduced-Function Device (RFD). An FFD is capable of providing a Personal Area Network Coordinator (PAN Coordinator, serving as a master node), a coordinator (serving as a relay node) and a RFD (serving as a terminal node). An FFD is able to communicate with other FFDs and an RFD. An RFD is a simple network equipment for communicate with an FFD only. In other words, an RFD can only be connected with one coordinator and hence has a smaller data amount for transmission and occupies fewer system resources.

Refer to FIG. 1, which is a schematic diagram of a superframe adapted for the IEEE 802.15.4 standard. A coordinator of a beacon network under the IEEE 802.15.4 standard sends beacons 11a and 11b to synchronize the timing in the whole beacon network. A time interval defined by the two consecutive beacons 11a and 11b is one superframe 12. In other words, a time length of the superframe 12 equals to a beacon interval. The superframe 12 can also be divided into an active period 13 and an inactive period 14, wherein the active period 13 can be further divided into 16 time slots in the same size. If a node, the aforementioned FFD or RFD, in the beacon network intends to transmit data, an appropriate number of time slots must be selected from the 16 time slots. During the inactive period 14, the node enters a power-saving or suspended mode. To be more specific, each of the aforementioned 16 time slots is classified into one of a Contention Access Period (CAP) and a Contention Free Period (CFP). In FIG. 1, time slots 0˜3 are CAP time slots and time slots 4˜15 are CFP time slots. The difference between CAP and CFP is that only nodes that have registered in the coordinator can use the CFP, while other nodes use CAP time slots for transmission.

In the IEEE 802.15.4 standard, lengths of the beacon interval 12 and the active period 13 can be derived from the following equation (1) and equation (2) respectively:

BI=aBaseSuperframeDuration×2^{BO} (1)

SD=aBaseSuperframeDuration×2^{SO} (2)

wherein the BI denotes the beacon interval 12, the SD denotes the active period 13, and the aBaseSuperframeDuration denotes a constant with a value of 160. The BO and the SO denote macBeaconOrder and macSuperframeOrder which are used to control the lengths of the beacon interval 12 and the length of the active period 13, respectively. The relation between the SO and the BO is 0≦SO≦BO≦14. The unit of both the lengths of the beacon interval 12 and the length of the active period 13 is symbols.

The aforementioned active period 13 is divided into 16 time slots, wherein the first time slot must be the CAP, and each of the remaining 15 time slots can be either the CAP or the CFP. A size of the time slot increases geometrically with respect to the SO parameter; that is, when the SO parameter increases by 1, the size of the time slot becomes double. Therefore, the SO parameter indirectly determines a smallest transmission time unit that can be reserved. With such a design, when a transmission time unit is large, the transmitted data with a smaller quantity often causes bandwidth wastes. However, if a smaller SO value is chosen, flexibility in using the time slot will be limited.

According to the aforementioned descriptions, the size of the time slots defined in the active period is fixed in the current beacon networks such as the IEEE 802.15.4 standard. In practical operation, how to select an appropriate size for the time slot to prevent the bandwidth from wasting is still a problem. Therefore, how to provide time slots in various sizes for transmission is an urgent task for the industry to endeavor.

### SUMMARY OF THE INVENTION

One object of this invention is to provide an apparatus for dividing a beacon interval. The apparatus comprises a decision module, a generation module, and a division module. The decision module is used for determining a first reference value and a second reference value, wherein the first reference value corresponds to a longest length of a sub-beacon interval derived after the division, and the second reference value corresponds to a shortest length of a sub-beacon interval derived after the division. The generation module is used for generating a plurality of sub-beacon lengths according to the first reference value and the second reference value. The division module is used for dividing a superframe duration (SD) of the beacon interval according to the sub-beacon lengths.

Another object of this invention is to provide a method for dividing a beacon interval. The method comprises the following steps: determining a first reference value and a second reference value, wherein the first reference value corresponds to a longest length of a sub-beacon interval, and the second reference value corresponds to a shortest length of a sub-beacon interval; generating a plurality of sub-beacon lengths according to the first reference value and the second reference value; and dividing a superframe duration of the beacon interval according to the sub-beacon lengths.

Yet a further objective of this invention is to provide a computer readable medium which stores an application program to execute the aforementioned method.

The present invention is capable of dividing a beacon interval into a plurality of time slots in various sizes. Therefore, the nodes can select a time slot with the most suitable size to perform data transmission to avoid wasting bandwidths.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram of a superframe duration of an IEEE 802.15.4 standard;

FIG. 2 is a schematic diagram of a first embodiment of this invention;

FIG. 3A is a schematic diagram of a superframe duration;

FIG. 3B is a schematic diagram of a divided beacon interval; and

FIG. 4 is a flow chart of a method of a second embodiment and a third embodiment of the invention.

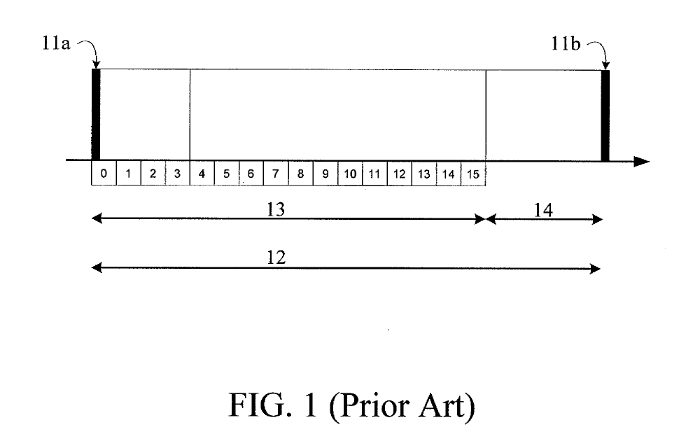

### DESCRIPTION OF THE PREFERRED EMBODIMENT

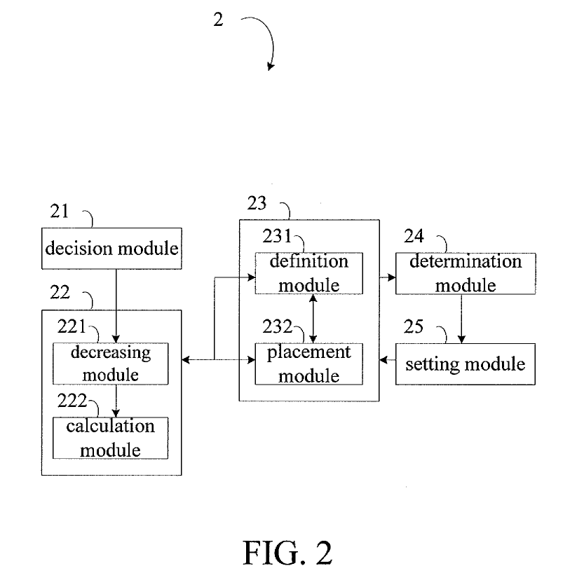

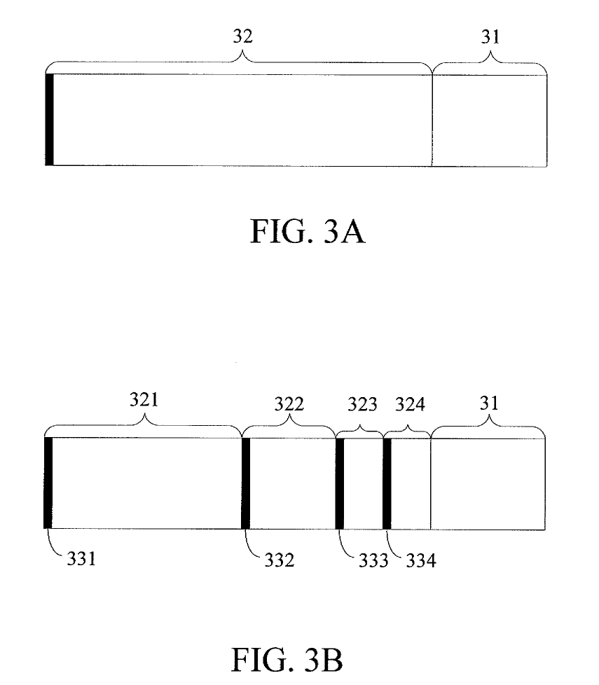

FIG. 2 depicts a first embodiment of this invention, which is an apparatus 2 for dividing a beacon interval. The beacon interval in this embodiment is a beacon interval defined by the IEEE 802.15.4 wireless network standard as shown in FIG. 3A. This beacon interval comprises an active period 32 and an inactive period 31. A length of the beacon interval is determined by the aforementioned equation (1) and a superframe duration in the beacon interval is determined by the aforementioned equation (2).

The apparatus 2 comprises a decision module 21, a generation module 22, a division module 23, a determination module 24, and a setting module 25. The generation module 22 comprises a decreasing module 221 and a calculation module 222. The division module 23 comprises a definition module 231 and a placement module 232.

The decision module 21 decides a first reference value and a second reference value, wherein the first reference value is the SO value corresponding to the longest length of a sub-beacon interval derived after the division, and the second reference value corresponds to the shortest length of the sub-beacon interval derived after the division. Since the IEEE 802.15.4/Zigbee standard defines the SO value ranging from 0 to 14, the decision module 21 sets the first reference value and the second reference value according to a practical condition or a predetermined value. Assume that the first reference value is set to 6 and the second reference value is set to 3 in the first embodiment. Generally speaking, if the second reference value is smaller than 3, the sub-beacon interval would be too small and causes too many operations.

Next, the generation module 22 generates a plurality of sub-beacon interval lengths according to the first reference value and the second reference value. Specifically speaking, the decreasing module 221 generates a plurality of indexes by decreasing progressively by one from the first reference value until the second reference value is reached. For example, the first index is the first reference value minus one, i.e. 6−1=5. The second and third indexes are 4 and 3. Then, the generation module 22 re-generates the last index, 3. Consequently, there are four indexes (5, 4, 3, and 3) in total generated. It is noted that the present invention does not have to re-generate the last index. The situation without repetition of the last index will be explained later. The calculation module 222 calculates each of the sub-beacon interval lengths according to each of the indexes (5, 4, 3, and 3) by the following equation:

SSD=aBaseSuperframeDuration×2^{x}

wherein, the SSD denotes a sub-beacon length, the aBaseSuperframeDuration is the first predetermined value, 160, defined by the IEEE 802.15.4 and the x denotes one of the indexes. Consequently, after substituting 5, 4, 3, and 3 into the equation, the calculation module 222 derives four sub-beacon lengths represented as SSD₁, SSD₂, SSD₃, and SSD₄, respectively. This shows that the first reference value is associated with the longest length of a sub-beacon interval and the second reference value is associated with the shortest length of the sub-beacon interval derived.

Next, the division module 23 divides a superframe duration of the beacon interval according to the sub-beacon lengths, i.e., SSD₁, SSD₂, SSD₃, and SSD₄ in a sequence from the longest one to the shortest one. Specifically speaking, the generation module 22 generates four beacons corresponding to the four sub-beacon lengths SSD₁, SSD₂, SSD₃, and SSD₄, respectively. As shown in FIG. 3B, the definition module 231 defines a plurality of sub-beacon intervals 321, 322, 323, and 324 in the beacon interval, wherein the length of each of the sub-beacon intervals 321, 322, 323, and 324 is determined by one of the sub-beacon lengths SSD₁, SSD₂, SSD₃, and SSD₄, respectively. The placement module 232 places corresponding beacons 331, 332, 333, and 334 at the beginning of the sub-beacon intervals 321, 322, 323, and 324. It is noted that the division module 23 is not necessary to divide the beacon interval in a sequence from the longest one to the shortest one. Other sequences are also applicable.

Next, the division module 23 further divides each of the sub-beacon intervals 321, 322, 323, and 324 into 16 time slots (not shown), similar to dividing a beacon interval into 16 time slots in the prior art. The time slots of each of the sub-beacon intervals 321, 322, 323, and 324 are distributed according to a ratio of the CAP and the CFP in the original beacon interval. For example, if the original beacon interval has 4 CAP time slots and 8 CFP time slots, each of the sub-beacon intervals 321, 322, 323, and 324 also defines 4 time slots as a sub-contention access period, and 8 time slots as a sub-contention free period. Similarly, the time slots of the sub-contention access period have higher priority than the time slots of the sub-contention free period. Then, the determination module 24 determines whether a summation of the lengths of the sub-beacon intervals 321, 322, 323, and 324 is smaller than the length of the superframe duration 32. In this embodiment, they are equal and thus the division of the beacon interval is finished.

The following will describe the condition that the summation of the lengths of the sub-beacon intervals and the length of the super frame duration is different. While generating the indexes as aforementioned, the last index is not necessary to be repeated. If only three indexes are generated, i.e., 5, 4, and 3, only three sub-beacon interval lengths SSD₁, SSD₂ and SSD₃ are generated. That is, there are only three sub-beacon intervals 321, 322, and 323. Similarly, each of the sub-beacon intervals 321, 322, and 323 is divided into 16 time slots. The ratio of the sub-contention access period and the sub-contention free period of each of the sub-beacon intervals 321, 322, and 323 is the same as the ratio of the CAP and the CFP of the beacon interval. The determination module 24 determines that the summation of the lengths of the sub-beacon intervals 321, 322, and 323 is shorter than the length of the superframe duration 32. The setting module 25 sets the remaining length as an inactive period, i.e., sets the interval 324 as the inactive period. Consequently, the whole inactive period is a total period including the interval 324 and the interval 31. Nevertheless, since the summation of the three sub-beacon intervals are smaller than the superframe duration 32, a summation of the sub-contention access period is smaller than the CAP, and a summation of the sub-contention free period is smaller than the CFP.

Please note that the first embodiment can be used at different stages of the beacon network. During the stage of initializing the beacon network, an FFD, serving as a mother node, builds the beacon network. A ratio of the sub-contention access period and the sub-contention free period can not be determined in advance so that only the sub-contention access periods exist since the beacon network comprises only the mother node currently. Afterwards, when a new FFD or an RFD joins the beacon network as a child node and requests to use the bandwidth, the mother node will reduce the time period for the sub-contention access period and increase the time period for the sub-contention free period according to a network usage condition. In other words, the ratio of the sub-contention access period and the sub-contention free period changes from time to time according to the instant network condition. Furthermore, the first embodiment can also be applied to a beacon network under another standard but not the IEEE 802.15.4 standard.

Accordingly, the first embodiment can divide the beacon interval into time slots in various sizes. Data can be loaded into a time slot with a suitable size to prevent the bandwidth from wasting. In addition, since available time slots of the sub-contention free periods increase, sending packets in the CAP is avoided, which also reduces the possibility of packet collisions. Therefore, the accidents of data retransmission are reduced.

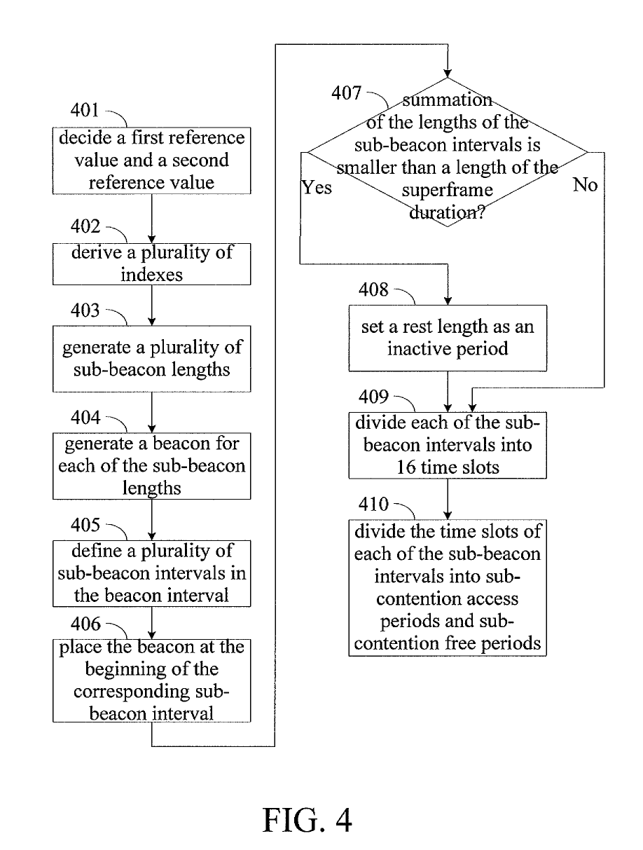

The second embodiment of this invention is a method for dividing a beacon interval, whose flow chart is depicted in FIG. 4. The beacon interval of this embodiment is also a beacon interval conforming to the IEEE 802.15.4 wireless network standard.

First, step 401 is executed to decide a first reference value and a second reference value according to a practical condition or a predetermined value, wherein the first reference value is the SO value corresponding to the longest length of the divided sub-beacon interval and the second reference value corresponds to the shortest length of the divided sub-beacon interval. Next, step 402 is executed to derive a plurality of indexes by decreasing progressively by one from the first reference value until the second reference value is reached. Next, step 403 executing to generate each of the sub-beacon lengths according to each of the indexes. Specifically speaking, each of the sub-beacon lengths is calculated according to the equation:

SSD=aBaseSuperframeDuration×2^{x}

wherein SSD denotes a sub-beacon length, aBaseSuperframeDuration denotes the first predetermined value, and x denotes one of the indexes. Next, a superframe duration of the beacon interval is divided according to the sub-beacon lengths, from the longest one to the shortest one. Specifically speaking, step 404 is executed first to generate a beacon corresponding to each of the sub-beacon lengths, respectively. Next, step 405 is executed to define a plurality of sub-beacon intervals in the beacon interval, wherein the length of each of the sub-beacon intervals is determined by one of the sub-beacon lengths. Next, step 406 is executed to place the beacon at the beginning of the corresponding sub-beacon interval. Next, step 407 is executed to determine whether a summation of the lengths of the sub-beacon intervals is smaller than a length of the superframe duration. If yes, step 408 is executed to set the rest length of the superframe duration as an inactive period. Next, step 409 is executed to divide each of the sub-beacon intervals into 16 time slots. Next, step 410 is executed for dividing the time slots of each of the sub-beacon intervals 321, 322, 323, and 324 according to a ratio of the CAP and the CFP in the original beacon interval. If the result of step 407 is that the summation of these beacon lengths is not smaller than the length of the superframe duration, step 409 is executed directly.

In addition to the aforementioned steps, the second embodiment also is able to execute all the operations of the first embodiment. People skilled in the art can understand the corresponding steps or operations of the second embodiment via explanations of the first embodiment, and thus giving no unnecessary details.

According to the aforementioned steps, the second embodiment can divide the beacon interval into time slots in various sizes. Data can be loaded into a time slot with a suitable size to prevent the bandwidth from wasting. In addition, since the number of available time slots of the sub-contention free periods increases, sending packets in the CAP can be avoided to further reduce an occurrence possibility of packet collisions and therefore the accidents of data retransmission are reduced.

A third embodiment of this invention is another method for dividing a beacon interval. This method is applied to the apparatus 2 of the first embodiment. Please refer to FIG. 2 and FIG. 4. First, step 401 is executed to enable the decision module 21 to decide a first reference value and a second reference value according to the practical condition or a predetermined value, wherein the first reference value corresponds to the longest length of the divided sub-beacon interval and the second reference value corresponds to the shortest length of the divided sub-beacon interval. Next, step 402 is executed to enable the decreasing module 221 to derive a plurality of indexes by decreasing progressively by one from the first reference value until the second reference value is reached. Next, step 403 is executed to enable the generation module 22 to generate each of the sub-beacon lengths according to each of the indexes. Specifically speaking, the calculation module 222 of the generation module 22 is enabled to calculate each of the sub-beacon lengths according to the following equation:

SSD=aBaseSuperframeDuration×2^{x}

wherein SSD denotes a sub-beacon length, aBaseSuperframeDuration denotes the first predetermined value, and x denotes the corresponding index for the one of the sub-beacon lengths.

Next, the division module 23 is enabled to divide the superframe duration of the beacon interval from longest one to the shortest one according to the sub-beacon lengths. Specifically speaking, step 404 is executed to enable the generation module 22 to generate a beacon corresponding to each of the sub-beacon lengths. Next, step 405 is executed to enable the definition module 231 to define a plurality of sub-beacon intervals in the beacon interval and a length of each of the sub-beacon intervals is determined based on one of the sub-beacon lengths. Next, step 406 is executed to enable the placement module 232 to place the beacon at the beginning of the corresponding sub-beacon interval. Next, step 407 is executed to enable the determination module 24 to determine whether a summation of the lengths of the sub-beacon intervals is smaller than a length of the superframe duration. If yes, step 408 is executed to enable the setting module 25 to set a rest length of the superframe duration as an inactive period. Next, step 409 is executed to enable the division module 23 to divide each of the sub-beacon intervals into 16 time slots. Then, step 410 is executed to enable the division module 23 to divide the time slots of each of the sub-beacon intervals 321, 322, 323, and 324 according to a ratio of the sub-contention access period and the sub-contention free period in the original beacon interval. If the result of step 407 is that the summation of these beacon lengths is not smaller that the length of the superframe duration, step 409 is executed directly.

In addition to the aforementioned steps, the third embodiment is also able to execute all the operations of the first embodiment. People skilled in the art can understand the corresponding steps or operations of the third embodiment via explanations of the first embodiment, and thus giving no unnecessary details.

According to the aforementioned steps, the third embodiment can divide a beacon interval into time slots in various sizes. Data can be loaded into a suitable time slot based on a corresponding size to prevent the bandwidth from wasting. In addition, since a number of available time slots of the sub-contention free periods increases, sending packets in the CAP is avoided to further reduce an occurrence possibility of packet collisions and therefore accidents of data retransmission are reduced.

The aforementioned methods can be implemented by an application program. More particularly, an apparatus is installed the application program to execute the aforementioned methods. The application program can be stored in a computer readable medium. The computer readable medium can be a floppy disk, a hard disk, an optical disc, a flash disk, a database accessible from a network, or any storage medium with the same functionality that can be easily thought by people who are ordinary skilled in the art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for dividing a beacon interval, comprising:
a decision module for deciding a first reference value and a second reference value, the first reference value corresponding to a longest length of a sub-beacon interval derived after the division, and the second reference value corresponding to a shortest length of the sub-beacon interval derived after the division;
a generation module for generating a plurality of sub-beacon lengths according to the first reference value and the second reference value; and
a division module for dividing a superframe duration of the beacon interval according to the sub-beacon lengths.

2. The apparatus of claim 1, wherein the generation module comprises:
a decreasing module for deriving a plurality of indexes by continuously decreasing by one from the first reference value minus one until the second reference value is reached;
wherein the generation module generates the sub-beacon lengths according to each of the indexes.

3. The apparatus of claim 1, wherein the division module comprises:
a definition module for defining a plurality of sub-beacon intervals in the beacon interval, a length of each of the sub-beacon intervals being determined based on one of the sub-beacon lengths; and
a placement module;
wherein the generation module further generates a beacon for each of the sub-beacon lengths, and the placement module places the beacon at the beginning of the corresponding sub-beacon interval.

4. The apparatus of claim 3, wherein the generation module comprises a calculation module for generating each of the sub-beacon lengths according to the following equation:
SSD=aBaseSuperframeDuration×2^{x}
wherein SSD denotes one of the sub-beacon lengths, aBaseSuperframeDuration denotes a first predetermined value, and x denotes the corresponding index for the one of the sub-beacon lengths.

5. The apparatus of claim 4, wherein each of the sub-beacon intervals comprises a sub-Contention Access Period (CAP) and a sub-Contention Free Period (CFP), a summation of the sub-CAPs is not longer than a CAP of the beacon interval, and a summation of the sub-CFPs is not longer than a CFP of the beacon interval.

6. The apparatus of claim 1, wherein the division module divides the beacon interval in a sequence from long to short according to the sub-beacon lengths.

7. The apparatus of claim 1, further comprising:
a determination module for determining whether a summation of the lengths of the sub-beacon intervals is smaller than a length of the superframe duration; and
a setting module for setting a rest length of the superframe duration as an inactive period if the summation is smaller than the length of the superframe duration.

8. A method for dividing a beacon interval, comprising the steps of:
deciding a first reference value and a second reference value, the first reference value corresponding to a longest length of a sub-beacon interval derived after the division, and the second reference value corresponding to a shortest length of the sub-beacon interval derived after the division;
generating a plurality of sub-beacon lengths according to the first reference value and the second reference value; and
dividing a superframe duration of the beacon interval according to the sub-beacon lengths.

9. The method of claim 8, wherein the generating step comprises the steps of:
deriving a plurality of indexes by continuously decreasing by one from the first reference value minus one until the second reference value is reached; and
generating the sub-beacon lengths according to each of the indexes.

10. The method of claim 8, wherein the dividing step comprises the steps of:
generating a beacon for each of the sub-beacon lengths,
defining a plurality of sub-beacon intervals in the beacon interval, a length of each of the sub-beacon intervals being determined based on one of the sub-beacon lengths; and
placing the beacon at the beginning of the corresponding sub-beacon interval.

11. The method of claim 10, wherein the generating step comprises the step of:
calculating each of the sub-beacon lengths according to the following equation:
SSD=aBaseSuperframeDuration×2^{x}
wherein SSD denotes one of the sub-beacon lengths, aBaseSuperframeDuration denotes a first predetermined value, and x denotes the corresponding index for the one of the sub-beacon lengths.

12. The method of claim 11, wherein each of the sub-beacon intervals comprises a CAP and a CFP, a summation of the sub-CAPs is not longer than a CAP of the beacon interval, and a summation of the sub-CFPs is not longer than a CFP of the beacon interval.

13. The method of claim 8, wherein the dividing step divides the beacon interval in a sequence from long to short according to the sub-beacon lengths.

14. The method of claim 8, further comprising the steps of:
determining whether a summation of the lengths of the sub-beacon intervals is smaller than a length of the superframe duration; and
setting a rest length of the superframe duration as an inactive period if the summation is smaller than the length of the superframe duration.

15. A computer readable medium, storing an application program to execute a method for dividing a beacon interval, the method comprising the steps of:
deciding a first reference value and a second reference value, the first reference value corresponding to a longest length of a sub-beacon interval derived after the division, and the second reference value corresponding to a shortest length of the sub-beacon interval derived after the division;
generating a plurality of sub-beacon lengths according to the first reference value and the second reference value; and
dividing a superframe duration of the beacon interval according to the sub-beacon lengths.

16. The computer readable medium of claim 15, wherein the generating step comprises the steps of:
deriving a plurality of indexes by continuously decreasing by one from the first reference value minus one until the second reference value is reached; and
generating the sub-beacon lengths according to each of the indexes.

17. The computer readable medium of claim 15, wherein the dividing step comprises the steps of:
generating a beacon for each of the sub-beacon lengths,
defining a plurality of sub-beacon intervals in the beacon interval, a length of each of the sub-beacon intervals being determined based on one of the sub-beacon lengths; and
placing the beacon at the beginning of the corresponding sub-beacon interval.

18. The computer readable medium of claim 17, wherein the generating step comprises the step of:
calculating each of the sub-beacon lengths according to the following equation:
SSD=aBaseSuperframeDuration×2^{x}
wherein SSD denotes one of the sub-beacon lengths, aBaseSuperframeDuration denotes a first predetermined value, and x denotes the corresponding index for the one of the sub-beacon lengths.

19. The computer readable medium of claim 18, wherein each of the sub-beacon intervals comprises a CAP and a CFP, a summation of the sub-CAPs is not longer than a CAP of the beacon interval, and a summation of the sub-CFPs is not longer than a CFP of the beacon interval.

20. The computer readable medium of claim 15, wherein the dividing step divides the beacon interval in a sequence from long to short according to the sub-beacon lengths.

21. The computer readable medium of claim 15, the method further comprising the steps of:
determining whether a summation of the lengths of the sub-beacon intervals is smaller than a length of the superframe duration; and
setting a rest length of the superframe duration as an inactive period if the summation is smaller than the length of the superframe duration.
